(19) United States
(12) Patent Application Publication
(10) Pub. No.: US 2011/0245389 A1
(43) Pub. Date: Oct. 6, 2011

(54) TRANSPARENT FLAME-RETARDANT AROMATIC POLYCARBONATE RESIN COMPOSITION, AND MOLDED PRODUCT THEREOF

(75) Inventors: Aki Yamada, Chiba (JP); Koichi Suga, Chiba (JP)

(73) Assignee: IDEMITSU KOSAN CO., LTD., TOKYO (JP)

(21) Appl. No.: 13/063,654

(22) PCT Filed: Sep. 18, 2009
(86) PCT No.: PCT/JP09/66404

§ 371 Date: Jun. 7, 2011

(30) Foreign Application Priority Data
Oct. 7, 2008 (JP) 2008-260877
Jul. 17, 2009 (JP) 2009-169021

(51) Int. Cl. C08L 69/00; C08K 5/42; C08L 83/04

(52) U.S. Cl. 524/166; 525/464

(57) ABSTRACT

A polycarbonate resin composition that is enhanced in flame retardancy while maintaining transparency containing (A) a polycarbonate resin component containing from 10 to 90% by mass of (A-1) an aromatic polycarbonate resin containing a dihydroxybiphenyl as a part of a dihydric phenol, from 10 to 90% by mass of (A-2) an aromatic polycarbonate-polyorganosiloxane copolymer, and from 0 to 80% by mass of (A-3) an aromatic polycarbonate resin other than (A-1) and (A-2), and a molded product thereof. In the flame retardant polycarbonate resin composition, the content of the polyorganosiloxane in (A) is preferably from 0.3 to 1.6% by mass, and the composition may contain from 0.01 to 1 part by mass of (B) an organic metal salt per 100 parts by mass of (A).

### TECHNICAL FIELD

The present invention relates to a transparent flame retardant polycarbonate resin composition and a molded product thereof, and more specifically, relates to a polycarbonate resin composition that has excellent flame retardancy while maintaining transparency, and is favorably applied to an office automation equipment, an electric and electronic member, an optical member, a building part, an electric and electronic equipment, an information and communication equipment and the like, and a molded product thereof.

### BACKGROUND ART

A polycarbonate resin is widely used as materials or the like of an office automation equipment, an electric or electronic part, a household product, a building part, an automobile part and the like, owing to the excellent impact resistance, heat resistance, electric characteristics and the like thereof.

A polycarbonate resin has higher flame retardancy as compared to a polystyrene resin and the like, but there are application fields that require further higher flame retardancy, and the flame retardancy thereof is enhanced by the addition of various kinds of flame retardants.

As the flame retardant added, for example, an organic halogen compound and an organic phosphorus compound have been ordinarily used. However, these flame retardants have a problem of toxicity, and in particular, an organic halogen compound has a problem of generation of a corrosive gas on combustion. In recent years, accordingly, there is an increasing demand of flame retardancy achieved without the use of the halogen or phosphorus flame retardant.

A polycarbonate resin with excellent transparency in addition to flame retardancy is also increasingly demanded in the fields including an office automation equipment and the like.

For example, a polycarbonate copolymer using a dihydroxybiphenyl as a part of a dihydric phenol, a polyorganosiloxane-containing polycarbonate and the like are resins having transparency and have been known (see Patent Documents 1 and 2). However, it is the current situation that these resins are proposed as resin composition, to which another resin is added (see Patent Documents 3, 4 and 5).

For example, Patent Document 3 to 5 disclose resin compositions that contain a copolymer polycarbonate containing a dihydroxybiphenyl and an amorphous styrene resin (Patent Document 3), an aliphatic polyester resin (Patent Document 4) or a polyorganosiloxane-containing graft copolymer (Patent Document 5) as essential components, and also contain a polyorganosiloxane-containing polycarbonate or the like as arbitrary components.

However, the addition of the amorphous styrene resin, the aliphatic polyester resin or the polyorganosiloxane-containing graft copolymer makes the resulting resin compositions opaque.

Furthermore, it has been known that a composition of an ordinary aromatic polycarbonate and an aromatic polycarbonate-polyorganosiloxane copolymer is changed in flame retardancy depending on the repeating number of organosiloxane in the polyorganosiloxane and the amount of the polyorganosiloxane in the composition (see Non-patent Document 1), and it has not yet been confirmed as to whether or not a composition containing a copolymer polycarbonate containing a dihydroxybiphenyl and an aromatic polycarbonate-polyorganosiloxane copolymer exhibits the similar flame retardancy.

### RELATED ART DOCUMENTS

### Patent Documents

[Patent Document 1] JP-A-62-227927
[Patent Document 2] JP-A-50-29695
[Patent Document 3] JP-A-2005-255724
[Patent Document 4] JP-A-2006-232956
[Patent Document 5] JP-A-2007-169433

### Non-Patent Document

[Non-patent Document 1] Nodera, A. and Kanai, T., J. Appl. Polym. Sci., vol. 102, p. 1697 (2006)

### SUMMARY OF THE INVENTION

### Problems to be Solved by the Invention

An object of the present invention is to provide a polycarbonate resin composition that is enhanced in flame retardancy while maintaining transparency of a total light transmittance of 80% or more, and a molded product thereof. Another object of the present invention is to provide a resin composition with higher flame retardancy by clarifying an aromatic polycarbonate-polyorganosiloxane copolymer that maximizes the flame retardancy of a composition of the aromatic polycarbonate-polyorganosiloxane copolymer and a copolymer polycarbonate containing a component derived from a dihydroxybiphenyl, and a molded product thereof.

### Means for Solving the Problems

As a result of earnest investigations made by the inventors for achieving the objects, a transparent polycarbonate resin composition excellent in flame retardancy has been developed, and the objects are achieved by the present invention described in the following items 1 to 7.

1. A transparent flame retardant polycarbonate resin composition containing (A) a polycarbonate resin component comprising from 10 to 90% by mass of (A-1) an aromatic polycarbonate resin containing a dihydroxybiphenyl as a part of a dihydric phenol, from 10 to 90% by mass of (A-2) an aromatic polycarbonate-polyorganosiloxane copolymer, and from 0 to 80% by mass of (A-3) an aromatic polycarbonate resin other than (A-1) and (A-2).

2. The transparent flame retardant polycarbonate resin composition according to the item 1, which contains from 0.01 to 1 part by mass of (B) an organic metal salt per 100 parts by mass of (A).

3. The transparent flame retardant polycarbonate resin composition according to the item 1 or 2, wherein the polyorganosiloxane of the aromatic polycarbonate-polyorganosiloxane copolymer is polydimethylsiloxane.

4. The transparent flame retardant polycarbonate resin composition according to the item 1 or 2, wherein a content of the polyorganosiloxane in (A) is 0.3% by mass or more and less than 1.6% by mass.

5. The transparent flame retardant polycarbonate resin composition according to the item 2, wherein the organic metal salt (B) is an organic alkali metal salt and/or an organic alkaline earth metal salt.

6. The transparent flame retardant polycarbonate resin composition according to the item 5, wherein the organic alkali metal salt and/or the organic alkaline earth metal salt is at least one selected from an alkali metal sulfonate salt, an alkaline earth metal sulfonate salt, an alkali metal polystyrenesulfonate salt and an alkaline earth metal polystyrenesulfonate salt.

7. A molded product containing the transparent flame retardant polycarbonate resin composition according to anyone of the items 1 to 6.

### Advantages of the Invention

According to the invention, a polycarbonate resin composition that is transparent (with a total light transmittance of 80% or more) and is excellent in flame retardancy, and a molded product thereof are provided.

### MODE FOR CARRYING OUT THE INVENTION

The present invention will be described in more detail.

The present invention relates to a transparent flame retardant polycarbonate resin composition containing (A) a polycarbonate resin component containing from 10 to 90% by mass of (A-1) an aromatic polycarbonate resin containing a dihydroxybiphenyl as a part of a dihydric phenol, from 10 to 90% by mass of (A-2) an aromatic polycarbonate-polyorganosiloxane copolymer, and from 0 to 80% by mass of (A-3) an aromatic polycarbonate resin other than (A-1) and (A-2).

In the polycarbonate resin component (A) used in the present invention, the aromatic polycarbonate resin can be easily produced by reacting a dihydric phenol with a carbonate precursor, such as phosgene and a carbonate diester compound. Specifically, for example, the aromatic polycarbonate resin may be produced by reaction between a dihydric phenol and a carbonate precursor, such as phosgene, or ester exchange reaction between a dihydric phenol and a carbonate precursor, such as diphenyl carbonate, in the presence of a known catalyst and a known molecular weight controlling agent, in an inert organic solvent, such as methylene chloride.

### (A-1) Aromatic Polycarbonate Resin:

The aromatic polycarbonate resin (A-1) has repeating units represented by the following formulae (I) and (II).

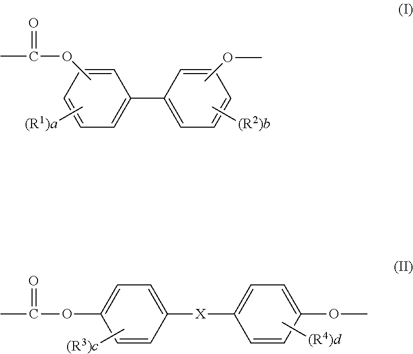

In the formulae (I) and (II), R¹ and R² each independently represent a group selected from a hydrogen atom, an alkyl group having from 1 to 6 carbon atoms, a cycloalkyl group having from 5 to 7 carbon atoms and a substituted or unsubstituted aryl group having from 6 to 12 carbon atoms. a and b each represent an integer of from 1 to 4. R³ and R⁴ each independently represent a hydrogen atom or an alkyl group having from 1 to 6 carbon atoms. c and d each represent an integer of from 1 to 4. X represents a single bond, an alkylene group having from 1 to 10 carbon atoms, an alkylidene group having from 2 to 10 carbon atoms, a cycloalkylene group having from 5 to 15 carbon atoms, a cycloalkylidene group having from 5 to 15 carbon atoms, an arylalkylene group having from 5 to 15 carbon atoms, —S—, —SO—, —SO₂—, —O—, —CO—, or a group represented by the following formula (II-1) or (II-2).

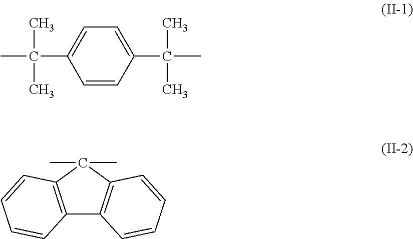

Examples of the compound having the repeating unit represented by the formula (I) include a reaction product of a dihydroxybiphenyl represented by the following formula (III), which is used as a part of a dihydric phenol, and a carbonate precursor.

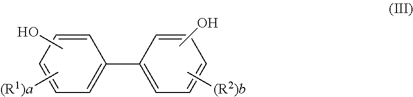

In the formula (III), R¹, R², a and b have the above-mentioned meanings.

Specific examples of the formula (III) include 4,4′-dihydroxybiphenyl, 3,3′-dimethyl-4,4′-dihydroxydiphenyl, 3,5,3′, 5′-tetramethyl-4,4′-dihydroxybiphenyl, 3,3′-diphenyl-4,4′-dihydroxybiphenyl and 2,3,5,6,2′, 3′, 5′, 6′-octafluoro-4,4′-dihydroxybiphenyl. Preferred examples among these include 4,4′-dihydroxybiphenyl. The dihydroxybiphenyl may be used solely or as a combination of two or more kinds thereof.

The dihydroxybiphenyl is used in combination with the dihydric phenol represented by the formula (IV) described later on polymerization of the aromatic polycarbonate, and the amount used is generally approximately from 5 to 50% by mol, and preferably from 5 to 43% by mol, based on the total amount of the dihydric phenol.

When the content of the dihydroxybiphenyl is 5% by mol or more, sufficient flame retardancy is obtained, and when it is 50% by mol or less, favorable impact resistance is obtained.

Examples of the compound having the repeating unit represented by the formula (II) include a reaction product of a dihydric phenol represented by the following formula (IV) and a carbonate precursor.

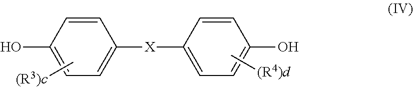

In the formula (IV), R³, R⁴, c and d have the above-mentioned meanings.

Specific examples of the compound represented by the formula (IV) include a dihydroxydiarylalkane compound, such as bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2,2-bis(4-hydroxyphenyl)propane (common name: bisphenol A), 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane and 2,2-bis(4-hydroxyphenyl)-1,1,1,3,3,3-hexafluoropropane; a dihydroxydiarylcycloalkane compound, such as 1,1-bis(4-hydroxyphenyl)cyclohexane, 1,1-bis(3,5-dichloro-4-hydroxyphenyl)cyclohexane and 1,1-bis(4-hydroxyphenyl)cyclodecane: a dihydroxydiarylsulfone compound, such as bis(4-hydroxyphenyl)sulfone, bis(3,5-dimethyl-4-hydroxyphenyl)sulfone and bis(3-chloro-4-hydroxyphenyl)sulfone; a dihydroxydiarylether compound, such as bis(4-hydroxyphenyl) ether and bis(3,5-dimethyl-4-hydroxyphenyl)ether; a dihydroxydiarylketone compound, such as 4,4′-dihydroxybenzophenone and 3,3′,5,5′-tetramethyl-4,4′-dihydroxybenzophenone; a dihydroxydiarylsulfide compound, such as bis(4-hydroxyphenyl)sulfide, bis(3-methyl-4-hydroxyphenyl)sulfide and bis(3,5-dimethyl-4-hydroxyphenyl)sulfide; a dihydroxydiarylsulfoxide compound, such as bis(4-hydroxyphenyl)sulfoxide; a dihydroxydiarylfluorene compound, such as 9,9-bis(4-hydroxyphenyl)fluorene; and α,α′-bis(4-hydroxyphenyl)-p-diisopropylbenzene, and preferred examples thereof include 2,2-bis(4-hydroxyphenyl)propane (common name: bisphenol A).

The dihydric phenol may be used solely or as a combination of two or more kinds thereof.

In the present invention, other compounds than the dihydric phenols represented by the formulae (III) and (IV) may be used, and examples thereof include a dihydroxybenzene compound, such as hydroquinone, resorcinol and methylhydroquinone, and a dihydroxynaphthalene compound, such as 1,5-dihydroxynaphthalene and 2,6-dihydroxynaphthalene.

### Carbonate Precursor:

Examples of the carbonyl source to be reacted with the formulae (III) and (IV) include phosgene, which is used for interfacial polymerization of an ordinary polycarbonate, triphosgene, bromophosgene, bis(2,4,6-trichlorophenyl) carbonate, bis(2,4-dichlorophenyl) carbonate, bis(2-cyanophenyl) carbonate and trichloromethyl chloroformate. Examples thereof also include a diaryl carbonate compound, a dialkyl carbonate compound and an alkylaryl carbonate, which are used for ester exchange reaction.

Specific examples of the diaryl carbonate compound include diphenyl carbonate, ditolyl carbonate, bis(chlorophenyl) carbonate, m-cresyl carbonate, dinaphthyl carbonate, bis(diphenyl) carbonate and bisphenol A bisphenyl carbonate, specific examples of the dialkyl carbonate compound include diethyl carbonate, dimethyl carbonate, dibutyl carbonate, dicyclohexyl carbonate and bisphenol A bismethyl carbonate, and specific examples of the alkylaryl carbonate compound include methylphenyl carbonate, ethylphenyl carbonate, butylphenyl carbonate, cyclohexylphenyl carbonate and bisphenol A methylphenyl carbonate.

### Molecular Weight Controlling Agent:

Any molecular weight controlling agent that is generally used for polymerization of polycarbonate may be used. Specific examples thereof include a monohydric phenol, such as phenol, p-cresol, p-tert-butylphenol, p-text-octylphenol, p-cumylphenol, p-nonylphenol, docosylphenol, tetracosylphenol, hexacosylphenol, octacosylphenol, triacontylphenol, dotriacontylphenol and tetratriacontylphenol. Among these monohydric phenols, p-tert-butylphenol and p-cumylphenol are preferably used. These compounds may be used solely or as a mixture of two or more kinds thereof. As the molecular weight controlling agent, another phenol compound may be used in combination in such a range that the advantages thereof is not impaired.

### Catalyst:

Preferred examples of the catalyst used include a tertiary amine and a salt thereof, a quaternary ammonium salt and a quaternary phosphonium salt. Examples of the tertiary amine include triethylamine, tributylamine, N,N-dimethylcyclohexylamine, pyridine and dimethylaniline, and examples of the tertiary amine salt include a hydrochlorate salt and a hydrobromate salt of these tertiary amines. Examples of the quaternary ammonium salt include trimethylbenzylammonium chloride, triethylbenzylammonium chloride, tributhylbenzylammonium chloride, trioctylmethylammonium chloride, tetrabutylammonium chloride and tetrabutylammonium bromide, and examples of the quaternary phosphonium salt include tetrabutylphosphonium chloride and tetrabutylphosphonium bromide. The catalyst may be used solely or as a combination of two or more kinds thereof. Among the catalysts, the tertiary amine is preferred, and triethylamine is particularly preferred.

### Inert Organic Solvent:

As the inert organic solvent, various kinds thereof may be used. Examples thereof include a chlorinated hydrocarbon, such as dichloromethane (methylene chloride), trichloromethane, carbon tetrachloride, 1,1-dichloroethane, 1,2-dichloroethane, 1,1,1-trichloroethane, 1,1,2-trichloroethane, 1,1,1,2-tetrachloroethane, 1,1,2,2-tetrachloroethane, pentachloroethane and chlorobenzene, toluene and acetophenone. The organic solvent may be used solely or as a combination of two or more kinds thereof. Among these, methylene chloride is particularly preferred.

As described above, the aromatic polycarbonate resin in the polycarbonate resin component (A) of the present invention is produced by reaction between the dihydric phenol and the carbonate precursor in the presence of the catalyst and the molecular weight controlling agent in the inert organic solvent, such as methylene chloride, and the viscosity average molecular weight of the aromatic polycarbonate resin thus produced is generally approximately from 10,000 to 50,000, preferably from 13,000 to 35,000, and more preferably from 15,000 to 20,000.

The viscosity average molecular weight (Mv) is obtained in such a manner that the viscosity of the methylene chloride solution is measured at 20° C. with an Ubbelohde viscometer, from which the limiting viscosity η is obtained, and the viscosity average molecular weight is obtained according to the following expression.

ρ=1.23×10⁻⁵ Mv^{0.83}

### (A-2) Aromatic Polycarbonate-Polyorganosiloxane Copolymer:

The aromatic polycarbonate-polyorganosiloxane copolymer (A-2) is constituted by an aromatic polycarbonate part and a polyorganosiloxane part, and contains an aromatic polycarbonate structural unit represented by the following general formula (V) and a polyorganosiloxane structural unit represented by the following general formula (VI).

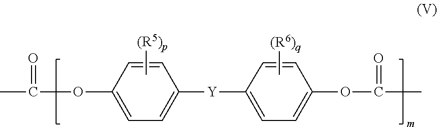

In the formula (V), R⁵ and R⁶ each represent a halogen atom, an alkyl group having from 1 to 6 (preferably from 1 to 4) carbon atoms or a phenyl group, which may have a substituent, and in the case where R⁵ and R⁶ each include plural group, the groups may be the same as or different from each other.

Y represents any one of a single bond, an alkylene group or alkylidene group having from 1 to 20 (preferably from 2 to 10) carbon atoms, a cycloalkylene group or cycloalkylidene group having from 5 to 20 (preferably from 5 to 12) carbon atoms, —O—, —S—, —SO—, —SO₂— and —CO—, and preferably an isopropylidene group.

p and q each represent an integer of from 0 to 4 (preferably 0), and p and q each include plural numbers, the numbers may be the same as or different from each other.

m represents an integer of from 1 to 100 (preferably from to 90. When m is from 1 to 100, the aromatic polycarbonate-polyorganosiloxane copolymer has a suitable viscosity average molecular weight.

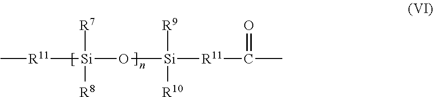

In the formula (VI), R⁷ to R¹⁰ each represent an alkyl group having from 1 to 6 carbon atoms or a phenyl group, which may have a substituent, and the groups may be the same as or different from each other. Specific examples of R⁷ to R¹⁰ include an alkyl group, such as a methyl group, an ethyl group, a propyl group, a n-butyl group, an isobutyl group, an amyl group, an isoamyl group and a hexyl group, and a phenyl-series aryl group, such as a phenyl group, a tolyl group, a xylyl group and a naphthyl group.

R¹¹ represents an organic residual group containing an aliphatic group or an aromatic group, and preferably a divalent organic compound residual group, such as an o-allylphenol residual group, a p-hydroxystyrene residual group and an eugenol residual group.

The aromatic polycarbonate-polyorganosiloxane copolymer can be produced, for example, by such a production method that an aromatic polycarbonate oligomer and a polyorganosiloxane having a reactive group at the end thereof constituting the polyorganosiloxane part are dissolved in a solvent, such as methylene chloride, and are subjected to interfacial polycondensation reaction by adding a dihydric phenol, such as bisphenol A, with a catalyst, such as triethylamine.

The aromatic polycarbonate-polyorganosiloxane copolymer is disclosed, for example, in JP-A-3-292359, JP-A-4-202465, JP-A-8-81620, JP-A-8-302178 and JP-A-10-7897.

In the aromatic polycarbonate-polyorganosiloxane copolymer, the polymerization degree of the aromatic polycarbonate structural unit is preferably from 3 to 100, and the polymerization degree of the polyorganosiloxane unit is preferably approximately from 2 to 500, more preferably approximately from 2 to 300, and further preferably approximately from 2 to 140. The content of the polyorganosiloxane in the aromatic polycarbonate-polyorganosiloxane copolymer is generally in a range of approximately from 0.1 to 10% by mass, and preferably from 0.3 to 6% by mass.

The viscosity average molecular weight of the aromatic polycarbonate-polyorganosiloxane copolymer used in the present invention is generally approximately from 5,000 to 100,000, preferably from 10,000 to 30,000, and particularly preferably from 12,000 to 30,000.

The viscosity average molecular weight (Mv) herein can be obtained in the same manner as that for the polycarbonate resin.

### (A-3) Aromatic Polycarbonate Resin:

The aromatic polycarbonate resin (A-3) may be any other aromatic polycarbonate than (A-1) and (A-2) without particular limitation, and examples thereof include various kinds thereof and preferably a polymer having a repeating unit having the structure represented by the general formula (II).

Furthermore, a polyfunctional aromatic compound may be used in combination of the dihydric phenol. Examples of the polyfunctional aromatic compound include 1,1,1-tris(4-hydroxyphenyl)ethane and α,α′,α″-tris(4-hydroxyphenyl)-1,3,5-triisopropylbenzene. The polycarbonate resin (A-3) may be used depending on necessity in a range of from 0 to 80% by mass in (A).

The content of the polyorganosiloxane in (A), which is the total amount of (A-1) and (A-2) (the total amount of (A-1), (A-2) and (A-3) when (A-3) is used), may be approximately 0.3% by mass or more and less than 1.6% by mass, and more preferably from 1 to 1.5% by mass, whereby the resulting composition of the present invention is improved in flame retardancy.

(B) Organic Alkali Metal Salt and/or Organic Alkaline Earth Metal Salt

For further enhancing the flame retardancy of the polycarbonate resin composition of the present invention, at least one kind selected from an organic alkali metal salt and/or an organic alkaline earth metal salt may be added depending on necessity.

Examples of the organic alkali metal salt and/or the organic alkaline earth metal salt used include various kinds thereof, and an alkali metal salt and an alkaline earth metal salt of an organic acid having at least one carbon atom or an organic acid ester may be used.

Examples of the organic acid or the organic acid ester herein include an organic sulfonic acid and an organic carboxylic acid. Examples of the alkali metal include lithium, sodium, potassium and cesium, and examples of the alkaline earth metal include magnesium, calcium, strontium and barium. Among these, salts of sodium and potassium are preferably used. The salt of the organic acid may be substituted by a halogen, such as fluorine, chlorine and bromine. The alkali metal salt and the organic alkaline earth metal salt may be used solely or as a combination of two or more kinds thereof.

Among the organic alkali metal salts and the organic alkaline earth metal salts, for example, in case of an organic sulfonic acid, an alkali metal salt and an alkaline earth metal salt of a perfluoroalkalnesulfonic acid represented by the following general formula (VII) are preferably used.

(CₑF₂ₑ₊₁SO₃)_{f}M (VII)

In the formula, e represents an integer of from 1 to 10,

M represents an alkali metal, such as lithium, sodium, potassium and cesium, or an alkaline earth metal, such as magnesium, calcium, strontium and barium, and f represents an atomic valence of M.

Examples of the compound include those described in JP-B-47-40445.

In the general formula (VII), examples of the perfluoroalkanesulfonic acid include perfluoromethanesulfonic acid, perfluoroethanesulfonic acid, perfluoropropanesulfonic acid, perfluorobutanesulfonic acid, perfluoromethylbutanesulfonic acid, perfluorohexanesulfonic acid, perfluoroheptanesulfonic acid and perfluorooctanesulfonic acid. In particular, potassium salts thereof are preferably used. Examples thereof also include alkali metal salts of an organic sulfonic acid, such as 2,5-dichlorobenzenesulfonic acid, 2,4,5-trichlorobenzenesulfonic acid, diphenylsulfone-3-sulfonic acid, diphenylsulfone-3,3′-disulfonic acid and naphthalenetrisulfonic acid.

Examples of the organic carboxylic acid include perfluoroformic acid, perfluoromethanecarboxylic acid, perfluoroethanecarboxylic acid, perfluoropropanecarboxylic acid, perfluorobutanecarboxylic acid, perfluoromethylbutanecarboxylic acid, perfluorohexanecarboxylic acid, perfluoroheptanecarboxylic acid and perfluorooctanecarboxylic acid, and alkali metal salts of the organic carboxylic acids may be used.

Examples of the alkali metal salt and/or the alkaline earth metal salt of polystyrenesulfonic acid include a sulfonate salt group-containing aromatic vinyl resin represented by the following general formula (VIII).

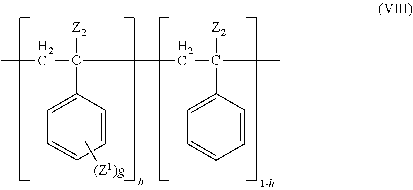

In the formula (VIII), Z¹ represents a sulfonate salt group, and Z² represents a hydrogen atom or a hydrocarbon group having from 1 to 10 carbon atoms. g represents an integer of from 1 to 5. h represents a molar fraction, which is 0<h≦1.

The sulfonate salt group herein is an alkali metal salt and/or an alkaline earth metal salt of sulfonic acid, and examples of the metal include sodium, potassium, lithium, rubidium, cesium, beryllium, magnesium, calcium, strontium and barium.

In the formula Z² represents a hydrogen atom or a hydrocarbon group having from 1 to 10 carbon atoms, and preferably a hydrogen atom or a methyl group. g is an integer of from 1 to 5, and h satisfies the relationship 0<h≦1. Accordingly, the sulfonate salt group (Z¹) may be substituted totally or partially on the aromatic ring.

For further enhancing the flame retardancy of the polycarbonate resin composition of the present invention, the substitution rate of the sulfonate salt group is determined in consideration of the content of the sulfonate salt group-containing aromatic vinyl resin and the like, and in general, a resin having a substitution of from 10 to 100% may be used.

In the alkali metal salt and/or the alkaline earth metal salt of the polystyrenesulfonic acid, the sulfonate salt group-containing aromatic vinyl resin is not limited to the polystyrene resin represented by the general formula (VII) and may be a copolymer of a styrene monomer and another monomer that can be copolymerized therewith.

Examples of the production method of the sulfonate salt group-containing aromatic vinyl resin include (1) a method of polymerizing or copolymerizing the aromatic vinyl monomer having a sulfonate salt group or the monomer and another monomer that can be copolymerized therewith, and (2) a method of sulfonating an aromatic vinyl polymer, a copolymer of an aromatic vinyl monomer and another monomer that can be copolymerized therewith, or a mixed polymer thereof, and neutralizing with an alkali metal compound and/or an alkaline earth metal compound.

As the method (2), for example, a mixed solution of concentrated sulfuric acid and acetic anhydride is added to a 1,2-dichloroethane solution of a polystyrene resin, and the resulting solution is heated for reacting for several hours, thereby producing a polystyrene sulfonated product. The resulting product is then neutralized with potassium hydroxide or sodium hydroxide in the same molar equivalent amount as the sulfonic acid group, thereby providing a potassium salt or a sodium salt of the polystyrenesulfonic acid.

The weight average molecular weight of the sulfonate salt group-containing aromatic vinyl resin used in the present invention may be approximately from 1,000 to 300,000, and preferably approximately from 2,000 to 200,000. The weight average molecular weight may be measured by a GPC method.

The polycarbonate resin composition (A) of the present invention contains a polycarbonate resin component containing from 10 to 90% by mass, more preferably from 50 to 88% by mass, of the aromatic polycarbonate resin containing a dihydroxybiphenyl as a part of a dihydric phenol (A-1), from 10 to 90% by mass, more preferably from 50 to 12% by mass, of the aromatic polycarbonate-polyorganosiloxane copolymer (A-2), and from 0 to 80% by mass of the aromatic polycarbonate resin (A-3) other than (A-1) and (A-2). When (A-1) is in the range of from 10 to 90% by mass, the flame retardancy is enhanced.

The amount of the alkali metal salt and/or the alkaline earth metal salt (B) added may be approximately from 0.01 to 1 part by mass, and preferably from 0.05 to 0.8 part by mass, per 100 parts by mass of the component (A).

When the amount of (B) mixed is 0.01 part by mass or more, the flame retardancy can be enhanced, and when it is 1 part by mass or less, the transparency of the polycarbonate resin composition can be maintained.

The transparent flame retardant polycarbonate resin composition of the present invention may contain, in addition to the components described above, an additive that has been used in an ordinary thermoplastic resin and a composition thereof, in an appropriate amount depending on characteristics demanded in the molded product, unless the transparency and the flame retardancy of the composition are impaired.

Examples of the additive include an antioxidant, an antistatic agent, an ultraviolet ray absorbent, a light stabilizer (weather resisting agent), a plasticizer, an antimicrobial agent, a solubilizing agent a colorant (such as a dye and a pigment).

The production method of the aromatic polycarbonate resin composition of the present invention will be described.

The aromatic polycarbonate resin composition of the present invention may be obtained by mixing and kneading the components (A-1) to (A-3) in the aforementioned proportions and (B) depending on necessity. The mixing and kneading may be performed with an apparatus that is ordinarily used, such as a ribbon blender and a drum tumbler, for preliminary mixing, and then an apparatus, such as a Henschel mixer, a Banbury mixer, a single screw extruder, a double screw extruder, a multi-screw extruder and a cokneader, and a forced ventilation type extruder that is a continuous extrusion molding machine, such as a single screw extrusion molding machine and a multi-screw extrusion molding machine, is preferably employed. An extrusion molding machine equipped with plural material feeding parts along the flow of the molding material may be preferably employed.

The heating temperature upon melt-kneading is generally selected appropriately from a range of from 200 to 320° C., and preferably from 220 to 280° C.

The aromatic polycarbonate resin composition of the present invention may be molded with the melt-kneading molding machine, or resulting pellets thereof as a raw material may be molded by an injection molding method, an injection and compression molding method, an extrusion molding method, a blow molding method, a press molding method, a vacuum molding method and a foaming molding method, thereby producing various molded products containing the aromatic polycarbonate resin composition. The aromatic polycarbonate resin composition of the present invention may be preferably applied to production of an injection molded product by injection molding or injection and compression molding, in which pellets of the composition are formed by the melt-kneading method, and then the pellets are used as the molding material. As the injection molding method, gas-injection molding may be employed for preventing shrinkage on appearance or for reducing the weight.

The molded product thus obtained may be applied widely to fields that require transparency and flame retardancy, for example, a housing and parts of an electric or electronic equipment, such as an office automation equipment, a duplicator, a facsimile, a personal computer, a printer, a television set, a radio receiver, a tape recorder, a video cassette recorder, a telephone set, an information terminal, a refrigerator and a microwave oven, and to other fields, such as an automobile part.

### EXAMPLE

The present invention will be described with reference to examples, but the invention is not limited thereto.

### Production Example 1

### Production of Polycarbonate-Dihydroxybiphenyl Copolymer

### (1) Synthesis of Polycarbonate Oligomer

To a sodium hydroxide aqueous solution having a concentration of 5.6% mass, sodium dithionite (Na₂S₂O₄) was added in an amount of 0.2% by mass based on bisphenol A (BPA) dissolved later, in which BPA was dissolved to a BPA concentration of 13.5% by mass, thereby preparing a sodium hydroxide aqueous solution of BPA. The sodium hydroxide aqueous solution of BPA and methylene chloride were made to flow continuously through a tubular reactor having an inner diameter of 6 mm and a tube length of 30 m at flow rates of 40 L/hr and 15 L/hr, respectively, and phosgene was also made flow continuously therethrough at a flow rate of 4.0 kg/hr. The tubular reactor had a jacket, and the temperature of the reaction liquid was maintained at 40° C. or less with cooling water passing through the jacket.

The reaction liquid coming out from the tubular reactor is introduced continuously to a tank reactor having an inner capacity of 40 L equipped with a sweepback wing and baffle, to which the sodium hydroxide aqueous solution of BPA was fed at a flow rate of 2.8 L/hr, a 25% by mass sodium hydroxide aqueous solution was fed at a flow rate of 0.07 L/hr, water was fed at a flow rate of 17 L/hr, and a 1% by mass triethylamine aqueous solution was fed at a flow rate of 0.64 L/hr, thereby performing reaction at 29 to 32° C. The reaction liquid was withdrawn continuously from the tank reactor, from which the aqueous phase was separated and removed by allowing to stand, thereby collecting the methylene chloride phase. The polycarbonate oligomer solution thus obtained had an oligomer concentration of 338 g/L and a chloroformate group concentration of 0.71 mol/L.

### (2) Polymerization of Polycarbonate-Dihydroxybiphenyl Copolymer

15.0 L of the oligomer solution, 10.0 L of methylene chloride, 94.5 g of p-tert-butylphenol (PTBP) and 1.7 mL of triethylamine were charged in a tank reactor having an inner capacity of 50 L equipped with a baffle plate and a paddle stirring blade, to which a sodium hydroxide aqueous solution of dihydroxybiphenyl (which was obtained by dissolving 615 g of 4,4′-dihydroxybiphenyl in an aqueous solution obtained by dissolving 615 g of sodium hydroxide and 4.5 g of sodium dithionite in 9.0 L of water) was added, followed by performing polymerization reaction for 1 hour. After adding 10.0 L of methylene chloride for dilution, the organic phase containing polycarbonate and an aqueous phase containing 4,4′-dihydroxybiphenyl and sodium hydroxide in an excessive amount were separated by allowing to stand, and the organic phase was isolated.

### (3) Rinsing

The methylene chloride solution of the polycarbonate-dihydroxybiphenyl copolymer obtained in the process of the section (2) was rinsed sequentially with a 0.03 mol/L sodium hydroxide aqueous solution in an amount of 15% by volume of the copolymer solution and then with 0.2 mol/L hydrochloric acid, and then repeatedly rinsed with pure water until the electroconductivity of the aqueous phase after rinsing reached 0.05 μS/m or less.

### (4) Flaking

The methylene chloride solution of the polycarbonate-dihydroxybiphenyl copolymer obtained in the process of the section (3) was concentrated and pulverized to provide flakes of the polycarbonate-biphenyl copolymer (A-1a). The resulting flakes were dried under reduced pressure at 120° C. for 12 hours. The resulting polycarbonate-biphenyl copolymer had My of 17,100 and a biphenyl content measured by a nuclear magnetic resonance (NMR) method of 15.2% by mol.

### Production Example 2

### Production of Polycarbonate-Dihydroxybiphenyl Copolymer

### (1) Synthesis of Polycarbonate Oligomer

To a sodium hydroxide aqueous solution having a concentration of 5.6% mass, sodium dithionite was added in an amount of 0.2% by mass based on BPA dissolved later, in which BPA and 4,4′-dihydroxybiphenyl at a ratio of 75/25 (by mol) were dissolved to a total concentration of BPA and 4,4′-dihydroxybiphenyl of 13.5% by mass, thereby preparing a sodium hydroxide aqueous solution of the monomers. The sodium hydroxide aqueous solution of the monomers and methylene chloride were made to flow continuously through a tubular reactor having an inner diameter of 6 mm and a tube length of 30 m at flow rates of 40 L/hr and 35 L/hr, respectively, and phosgene was also made flow continuously therethrough at a flow rate of 4.0 kg/hr. The tubular reactor had a jacket, and the temperature of the reaction liquid was maintained at 40° C. or less with cooling water passing through the jacket.

From the reaction liquid coming out from the tubular reactor, the aqueous phase was separated and removed by allowing to stand, thereby collecting the methylene chloride phase. The polycarbonate oligomer solution thus obtained had an oligomer concentration of 258 g/L, a chloroformate group concentration of 0.73 mol/L and a 4,4′-dihydroxybiphenyl content of 25% by mol.

### (2) Polymerization of Polycarbonate

171 mL of the oligomer solution, 54 mL of methylene chloride, 1.36 g of PTBP (p-tert-butylphenol) and 35 μl of triethylamine were charged in a tank reactor having an inner capacity of 1 L equipped with a baffle plate and a paddle stirring blade, to which a sodium hydroxide aqueous solution of bisphenol A (which was obtained by dissolving 12.8 g of bisphenol A in an aqueous solution obtained by dissolving 7.0 g of NaOH and 25 mg 1.8 g of sodium dithionite in 102 mL of water) was added, followed by performing polymerization reaction for 1 hour. After adding 200 L of methylene chloride for dilution, the organic phase containing polycarbonate and an aqueous phase containing excessive bisphenol A and NaOH were separated by allowing to stand, and the organic phase was isolated.

### (3) Rinsing

The methylene chloride solution of the copolymer polycarbonate obtained in the process of the section (2) was rinsed sequentially with a 0.03 mol/L sodium hydroxide aqueous solution in an amount of 15% by volume of the copolymer solution and then with 0.2 mol/L hydrochloric acid, and then repeatedly rinsed with pure water until the electroconductivity of the aqueous phase after rinsing reached 0.05 μS/m or less.

A part of the solution was dried under reduced pressure at 120° C. for 4 hours to provide a solid polycarbonate (A-1b). The resulting polycarbonate-biphenyl copolymer had My of 17,300 and a biphenyl content measured of 20.2% by mol.

### Production Example 3

### Production of Aromatic Polycarbonate-Polyorganosiloxane Copolymer

### (1) Production of Reactive PDMS

1,483 g of octamethylcyclotetrasiloxane, 96 g of 1,1,3,3-tetramethyldisiloxane and 35 g of 86% by mass sulfuric acid were mixed and stirred at room temperature for 17 hours. Thereafter, an oily phase was separated, to which 25 g of sodium hydrogencarbonate was added, followed by stirring for 1 hour. After filtering, the solution was distilled under vacuum at 150° C. and 3 torr (400 Pa) to remove the low boiling point components, thereby providing an oily product. 294 g of the oily product thus obtained was added to a mixture of 60 g of 2-allylphenol and platinum as 0.0014 g of a platinum chloride-alcoholate complex at a temperature of 90° C. The resulting mixture was stirred for 3 hours while maintaining at a temperature of from 90 to 115° C. The resulting product was extracted with methylene chloride and rinsed with 80% by mass aqueous methanol to remove excessive 2-allylphenol. The resulting product was dried with anhydrous sodium sulfate, and the solvent was distilled off in vacuum until the temperature reached 115° C. The reactive polydimethylsiloxane (PDMS) having allylphenol end groups had a repeating number of dimethylsilanoxy unit of 40 measured by NMR.

### (2) Production of PC-PDMS Copolymer

15.0 L of the oligomer solution obtained in the section (1) of Production Example 1, a solution obtained by dissolving 200.0 g of the reactive PDMS obtained in the section (1) in 500 mL of methylene chloride, 10.0 L of methylene chloride and 8.4 mL of triethylamine were charged in a tank reactor having an inner capacity of 50 L equipped with a baffle plate, a paddle stirring blade and a cooling jacket, to which 1.3 L of a 6.4% by mass sodium hydroxide aqueous solution was added, and the solution was reacted by stirring at 500 rpm and room temperature for 20 minutes. Subsequently, a solution obtained by dissolving 78.0 g of PTBP in 300 mL of methylene chloride and a sodium hydroxide aqueous solution of bisphenol A (which was obtained by dissolving 970 g of bisphenol A in an aqueous solution obtained by dissolving 550 g of NaOH and 1.9 g of sodium dithionite (Na₂S₂O₄) in 8.1 L of water) were added thereto, and the solution was reacted by stirring at 500 rpm and room temperature for 1 hour. After adding 10.0 L of methylene chloride for dilution, the organic phase containing polycarbonate and an aqueous phase containing excessive bisphenol A and NaOH were separated by allowing to stand, and the organic phase was isolated.

### (3) Rinsing

The methylene chloride solution of the PC-PDMS copolymer obtained in the process of the section (2) was rinsed sequentially with a 0.03 mol/L sodium hydroxide aqueous solution in an amount of 15% by volume of the copolymer solution and then with 0.2 mol/L hydrochloric acid, and then repeatedly rinsed with pure water until the electroconductivity of the aqueous phase after rinsing reached 0.05 μS/m or less.

### (4) Flaking

The methylene chloride solution of the PC-PDMS copolymer obtained in the process of the section (3) was concentrated and pulverized to provide flakes of the PC-PDMS copolymer (A-2). The resulting flakes were dried under reduced pressure at 120° C. for 12 hours. The resulting PC-PDMS copolymer had a viscosity average molecular weight of 17,000 and a PDMS content of 3.5% by mass. The PDMS content was measured in the following manner.

The PDMS content was obtained based on the intensity ratio of the peak of the methyl group of isopropyl of bisphenol A appearing at 1.7 ppm in ¹H-NMR and the peak of the methyl group of dimethylsiloxane appearing at 0.2 ppm.

### Production Example 4

### Production of Aromatic Polycarbonate-Polyorganosiloxane Copolymer

The same procedures as in the section (1) of Production Example 3 were performed except that the amount of 1,1,3,3-tetramethyldisiloxane was changed to 32.5 g in the section (1) of Production Example 3, thereby producing reactive PDMS having a repeating number of dimethylsilanoxy unit of 90. Subsequently, the same procedures as in Production Example 3 were performed except that the reactive PDMS having a repeating number of dimethylsilanoxy unit of 90 was used instead of the reactive PDMS having a repeating number of dimethylsilanoxy unit of 40 in the section (2) of Production Example 3, thereby producing a PC-PDMS copolymer. The resulting PC-PDMS copolymer had a viscosity average molecular weight of 17,000 and a PDMS content of 3.5% by mass.

### Production Example 5

### Production of Aromatic Polycarbonate-Polyorganosiloxane Copolymer

The same procedures as in the section (1) of Production Example 3 were performed except that the amount of 1,1,3,3-tetramethyldisiloxane was changed to 24 g in the section (1) of Production Example 3, thereby producing reactive PDMS having a repeating number of dimethylsilanoxy unit of 130. Subsequently, the same procedures as in Production Example 3 were performed except that the reactive PDMS having a repeating number of dimethylsilanoxy unit of 130 was used instead of the reactive PDMS having a repeating number of dimethylsilanoxy unit of 40 in the section (2) of Production Example 3, thereby producing a PC-PDMS copolymer. The resulting PC-PDMS copolymer had a viscosity average molecular weight of 17,000 and a PDMS content of 3.5% by mass.

### Examples 1 to 13 and Comparative Examples 1 to 6

The polycarbonate-dihydroxybiphenyl copolymer, the aromatic polycarbonate-polyorganosiloxane copolymer, the bisphenol A polycarbonate, a metal salt (potassium perfluorobutanesulfonate, produced by Dainippon Ink And Chemicals, Inc.) and 0.05 part by mass of an antioxidant (PEP36, produced by ADEKA Corporation) were mixed according to the mixing amounts shown in Table 1, and the mixtures were each dried, blended in a dry state, fed to an extruder, kneaded at a temperature of 280° C., and formed into pellets. The resulting pellets were dried at 120° C. for 12 hours, and injection-molded at a mold temperature of 80° C. and a molding temperature of 280° C., thereby producing test pieces.

The test pieces obtained in Examples and Comparative Examples were subjected to measurement of limiting oxygen index (LOI) and evaluation of transparency as evaluation of product quality. The results are shown in Table 1.

The limiting oxygen index was measured according to JIS K7210. The evaluation of transparency was performed by a total light transmittance, which was measured with a rectangular member with a dimension of 25 mm×25 mm and a thickness of 3.2 mm as a test piece by using a tester produced by Nippon Denshoku Industries Co., Ltd. according to JIS K7105.

TABLE 1

| | Comparative Example | | | | | | Example | | | |
|---|---|---|---|---|---|---|---|---|---|---|
| | 1 | 2 | 3 | 4 | 5 | 6 | 1 | 2 | 3 | 4 |
| A-1a | — | — | — | — | — | 5 | 91 | 85 | 76 | 76 |
| A-1b | — | — | — | 50 | 40 | — | — | — | — | — |
| A-2a | 15 | 30 | 43 | 30 | 30 | 5 | — | — | — | 24 |
| A-2b | — | — | — | — | — | — | 9 | 15 | 24 | — |
| A-2c | — | — | — | — | — | — | — | — | — | — |
| A-3 | 85 | 70 | 57 | — | — | 90 | — | — | — | — |
| B | — | — | — | — | — | — | — | — | — | — |
| ABS | — | — | — | 20 | — | — | — | — | — | — |
| Polylactic acid | — | — | — | — | 30 | — | — | — | — | — |
| PDMS amount in | 0.5 | 1.0 | 1.5 | 1.0 | 1.0 | 0.2 | 0.3 | 0.5 | 0.8 | 0.8 |
| composition | | | | | | | | | | |
| Limiting oxygen | 33 | 37 | 35 | 38 | 36 | 29 | 40 | 41 | 41 | 38 |
| index (LOI) | | | | | | | | | | |
| Total light | 91 | 90 | 80 | 30 | 30 | 90 | 85 | 84 | 83 | 90 |
| transmittance (%) | | | | | | | | | | |

| | Example | | | | | | | | |
|---|---|---|---|---|---|---|---|---|---|
| | 5 | 6 | 7 | 8 | 9 | 10 | 11 | 12 | 13 |
| A-1a | 71 | 71 | 71 | — | — | — | 33 | 50 | — |
| A-1b | — | — | — | 66 | 58 | 53 | — | — | 33 |
| A-2a | 29 | — | 29 | 34 | 42 | 47 | 34 | 34 | 34 |
| A-2b | — | — | — | — | — | — | — | — | — |
| A-2c | — | 29 | — | — | — | — | — | — | — |
| A-3 | — | — | — | — | — | — | 33 | 16 | 33 |
| B | — | — | 0.08 | — | — | — | — | — | — |
| ABS | — | — | — | — | — | — | — | — | — |
| Polylactic acid | — | — | — | — | — | — | — | — | — |
| PDMS amount in | 1.0 | 1.0 | 1.0 | 1.2 | 1.5 | 1.6 | 1.2 | 1.2 | 1.2 |
| composition | | | | | | | | | |
| Limiting oxygen | 39 | 39 | 39 | 40 | 40 | 36 | 39 | 39 | 41 |
| index (LOI) | | | | | | | | | |
| Total light | 90 | 80 | 89 | 89 | 91 | 89 | 89 | 89 | 85 |
| transmittance (%) | | | | | | | | | |

A-1a: Polycarbonate-dihydroxybiphenyl copolymer obtained in Production Example 1
A-1b: Polycarbonate-dihydroxybiphenyl copolymer obtained in Production Example 2
A-2a: Aromatic polycarbonate-polyorganosiloxane copolymer obtained in Production Example 3
A-2b: Aromatic polycarbonate-polyorganosiloxane copolymer obtained in Production Example 4
A-2c: Aromatic polycarbonate-polyorganosiloxane copolymer obtained in Production Example 5
A-3: Bisphenol A polycarbonate (FN1700A, produced by Idemitsu Kosan Co., Ltd., viscosity average molecular weight: 17,500)
Antioxidant: PEP36, produced by ADEKA Corporation
B: Potassium perfluorobutanesulfonate (C₄F₉SO₃K) (Megafac F114, produced by Dainippon Ink And Chemicals, Inc.)
ABS: Acrylonitrile-butadiene-styrene copolymer having rubber content of 60% by mass (B600N, produced by Ube Cyclon, Ltd.)
Polylactic acid: LACEA H-400 (produced by Mitsui Chemicals, Inc.)

The following matters are understood from Table 1.

(1) The compositions of Comparative Examples 1 to 3 and 6 are good in transparency but low in LOI value. Examples 1 to 13 have transparency that is equivalent to or higher than the comparative examples and are generally enhanced in LOT value.

(2) Comparative Examples 4 and 5 contain the ABS resin and the polylactic acid, respectively, but are considerably deteriorated in transparency.

(3) As understood from Examples 5 to 13, in the present invention, the maximum value of LOI value is obtained with a PDMS content around 1.5% by mass, and the LOI value is lowered when the content is 1.6% by mass.

More specifically, the following matters are found.

(4) As understood from Comparative Examples 1 and 2 and Examples 1 to 5, even when the PDMS amount in the composition is constant or is lowered, the use of the polycarbonate-dihydroxybiphenyl copolymer enhances the flame retardancy to an extent of a difference in LOT of from 5 to 8.

(5) As understood from Comparative Example 2 and Example 7, the flame retardancy can be enhanced without considerably decrease in transparency even when the metal salt is added.

(6) As understood from Comparative Examples 2 and 3 and Examples 8 and 9, the PDMS amount in the composition that provides the maximum LOI value is different between the bisphenol A polycarbonate and the polycarbonate-dihydroxybiphenyl copolymer, and the flame retardancy is enhanced synergistically by using the polycarbonate-dihydroxybiphenyl copolymer. Furthermore, as understood from Examples 11 to 13, the use of the bisphenol A polycarbonate in the polycarbonate-dihydroxybiphenyl copolymer and the aromatic polycarbonate-polyorganosiloxane copolymer provides synergistic enhancement in flame retardancy of the polycarbonate-dihydroxybiphenyl copolymer and the aromatic polycarbonate-polyorganosiloxane copolymer.

### INDUSTRIAL APPLICABILITY

The molded product obtained from the aromatic polycarbonate resin composition of the present invention may be applied widely to fields including a housing and parts of an electric or electronic equipment, such as an office automation equipment, a duplicator, a facsimile, a personal computer, a printer, a television set, a radio receiver, a tape recorder, a video cassette recorder, a telephone set, an information terminal, a refrigerator and a microwave oven, and to other fields, such as an automobile part.

1. A polycarbonate resin composition, comprising:
(A-1) an aromatic polycarbonate resin comprising a dihydroxybiphenyl as a part of a dihydric phenol, and;
(A-2) an aromatic polycarbonate-polyorganosiloxane copolymer:
wherein a content of (A-1) is from 10 to 90% by mass of total mass of said composition and;
a content of (A-2) is from 10 to 90% by mass of total mass of said composition.

2. The polycarbonate resin composition of claim 1, further comprising:
from 0.01 to 1 part by mass of (B) an organic metal salt per 100 parts by mass of (A) said composition.

3. The polycarbonate resin composition of claim 1, wherein the polyorganosiloxane of the aromatic polycarbonate-polyorganosiloxane copolymer is polydimethylsiloxane.

4. The polycarbonate resin composition of claim 1, wherein a content of the polyorganosiloxane of the aromatic polycarbonate-polyorganosiloxane copolymer is 0.3% by mass or more and less than 1.6% by mass of total mass of said composition.

5. The polycarbonate resin composition of claim 2, wherein the organic metal salt (B) is at least one selected from the group consisting of an organic alkali metal salt and an organic alkaline earth metal salt.

6. The polycarbonate resin composition of claim 2, wherein the organic metal salt (B) is at least one selected from the group consisting of an alkali metal sulfonate salt, an alkaline earth metal sulfonate salt, an alkali metal polystyrenesulfonate salt, and an alkaline earth metal polystyrenesulfonate salt.

7. A molded product comprising the polycarbonate resin composition of claim 1.

8. (canceled)

9. (canceled)

10. The polycarbonate resin composition of claim 1:
further comprising (A-3) an aromatic polycarbonate resin which is different from (A-1) and (A-2).

11. The polycarbonate resin composition of claim 10, wherein a content of (A-3) is up to 80% by mass of total mass of said composition.

12. The molded product of claim 7, whose limiting oxygen index is from 38 to 41.

13. The molded product of claim 7, whose total light transmittance percentage is from 80 to 100.
